(19) United States
(12) Patent Application Publication
(10) Pub. No.: US 2021/0019400 A1
(43) Pub. Date: Jan. 21, 2021

(54) SECURITY INFRASTRUCTURE AS A SERVICE

(71) Applicant: SecureNative Ltd., Tel Aviv-Yafo (IL)

(72) Inventors: Moshe ELGRESSY, Nofit (IL); Amit Eyal GOVRIN, Ramat Hasharon (IL); Alex IVANICHEV, Rishon Le Ziyon (IL)

(21) Appl. No.: 16/923,437

(22) Filed: Jul. 8, 2020

Related U.S. Application Data
(60) Provisional application No. 62/874,033, filed on Jul. 15, 2019.

(51) Int. Cl. G06F 21/55; G06F 21/57; G06F 9/54; G06F 8/30

(52) U.S. Cl. CPC G06F 21/556; G06F 21/577; G06F 2221/2133; G06F 8/31; G06F 9/547

(57) ABSTRACT

A method of providing security infrastructure as a service, comprising: setting plurality of pillars, each of which adapted to handle different aspect of security services of a cyber security platform; providing a flow manager that is configured to handle a plurality of flows, wherein each flow is an abstraction layer of various security services together with policies, workflows and automation that are deployed sequentially or in parallel; combining the input and output of the various security services in a unified response; and enabling writing enterprise-grade services using code-to-enterprise-grade-service platform capabilities, by uploading lines of code that responsible for the core/engine (e.g., intelligence service, check if email domain exists, etc.) and converting said uploaded lines of code to a service with APIs, High availability, Scalability, Authorization code, Documentation, etc.

### FIELD OF THE INVENTION

The present invention relates to the field of cyber security systems. More particularly, the invention relates to a method and system for protecting computer system from cyber security threats via a security platform for a unique wide range of cyber security domains, focus on specific use-cases. The platform consists of security services and components that can be written and tailored or use as part of the platform predefined and customized security solutions.

### BACKGROUND OF THE INVENTION

As many organizations connected to online public or private networks, such as the Internet, their computer systems have become the target of malicious activity. Unfortunately, such malicious activity allows an attacker to, for example, gain control of the computer system leading to the ex-filtration of sensitive information or installation of utilities that facilitate remote control of the computer system. As a result, many organizations invest in different cyber-security systems from various vendors.

The question that organizations are asking: Why is a new vendor relationship required each time a new security use-case comes along?

Moreover, current cyber security procedures and/or processes are fractured and disparate while lacking the ability to provide tailored-made protection according to the actual needs of an enterprise. As a result, enterprises lack the defensive and offensive capabilities to preclude, minimize and or offensively respond to cyber-attacks on their information systems.

To address these problems and to enable organizations to consume cyber security services that fit their actual needs in the age of modern Enterprise IT, where agility and flexibility is key for business success, and security use-cases are emerging on a recurring basis; deploying new security workflows combining multiple services and components, multi-cloud environments, and complete with the automated response is the answer and an object of the present invention.

It is another object of the present invention to provide a system which can enable organizations, in addition to tailoring, the ability of writing the enterprise-grade security services according to their needs.

Other objects and advantages of the invention will become apparent as the description proceeds.

### SUMMARY OF THE INVENTION

The present invention relates to a method of providing security infrastructure as a service, comprising:
Setting plurality of pillars, each of which adapted to handle different aspect of security services of a cyber security platform;
Providing a flow manager that is configured to handle a plurality of flows, wherein each flow is an abstraction layer of various security services together with policies, workflows and automation that are deployed sequentially or in parallel;
Combining the input and output of the various security services in a unified response; and
Enabling writing enterprise-grade services using code-to-enterprise-grade-service platform capabilities, by uploading lines of code that responsible for the core/engine (e.g., intelligence service, check if email domain exists, etc.) and converting said uploaded lines of code to a service with APIs, High availability, Scalability, Authorization code, Documentation, etc.

According to an embodiment of the invention, the flows are used to combine various services from multiple pillars together and create a use-case in accordance with specific needs of an enterprise.

According to an embodiment of the invention, the flows are triggered by the security platform upon schedule or in real-time upon requests in order to run a sequence of serial or parallel actions in response.

According to an embodiment of the invention, flows can be executed as auto-scaled automatically upon demand, thus resulting in variety of possibilities.

According to an embodiment of the invention, the flow manager uses Domain Specific Language (DSL) services linking as code to create the flows.

According to an embodiment of the invention, the flows are executed by execution triggers, contextual execution, or condition-based execution.

According to an embodiment of the invention, the flows comprising taking customized response data from a service and mutating it to customized response.

According to an embodiment of the invention, the method further comprises defining rules based on services parameters, thus the rules are detached from the services and yet can influence the service execution and results.

According to an embodiment of the invention, the flow manager enables to use API Keys for calling one or more APIs.

According to an embodiment of the invention, the method further comprises integrating a JavaScript agent in a browser for tracking activity on a website.

According to an embodiment of the invention, the JavaScript agent runs in the browser, collects several device signals and securely sends them to remote servers for calculating fingerprint, captcha and MFA.

According to an embodiment of the invention, the method further comprises receiving synchronous response via APIs, and asynchronies response from services via webhooks.

In another aspect, the present invention relates to a system, comprising:
at least one processor; and
a memory comprising computer-readable instructions which when executed by the at least one processor causes the processor to execute a SECURITY INFRASTRUCTURE AS A SERVICE, wherein the SECURITY INFRASTRUCTURE AS A SERVICE:

i) Sets plurality of pillars, each of which adapted to handle different aspect of security services of a cyber security platform;

ii) Provides a flow manager that is configured to handle a plurality of flows, wherein each flow is an abstraction layer of various security services together with policies, workflows and automation that are deployed sequential or in parallel; and

iii) combines the output of the various security services in a unified response.

According to an embodiment of the invention, the system further comprises a rule engine for defining rules based on services parameters, by detaching rules from the services.

### BRIEF DESCRIPTION OF THE DRAWING

In the drawings:

FIG. 1A shows a screen layout example of an adaptive authentication login flow in a graph form, according to an embodiment of the invention

FIG. 1B shows a code example of a device fingerprinting inspections service as part of the adaptive authentication login flow of the example of FIG. 1A, according to an embodiment of the invention;

FIG. 1C shows a screen layout of a code editor example of the adaptive authentication login flow of FIG. 1A, according to an embodiment of the invention;

FIG. 1D shows a screen layout example of a user interface of a flow manager, according to an embodiment of the invention;

FIG. 1E shows a screen layout example of a code for data and response mutation with respect to a device fingerprinting service, according to an embodiment of the invention;

FIG. 1F shows a screen layout example of defining rules based on services parameters, according to an embodiment of the invention;

FIG. 2 is a block diagram generally illustrating the architecture of a cyber security platform, according to an embodiment of the invention;

FIG. 3 is a block diagram generally illustrating a request flow, according to an embodiment of the invention;

FIG. 4 schematically illustrates an implementation of an adaptive authentication using the cyber security platform, according to an embodiment of the invention; and

FIG. 5 schematically illustrates an implementation of a security service in form of data leakage and protection using the cyber security platform, according to an embodiment of the invention.

### DETAILED DESCRIPTION OF THE INVENTION

Various terms are used throughout the description and the claims which should have conventional meanings to those with a pertinent understanding of computer programming. Additionally, various descriptive terms are used in describing the exemplary embodiments in order to facilitate an explanation of them, and to aid one's understanding. However, while the description to follow may entail terminology which is perhaps tailored to certain computing or programming environments, such as Application Programming Interface (API) or to the various embodiments themselves, it will be appreciated by a person skilled in the art that such terminology is employed in a descriptive sense and not a limiting sense. Where a confined meaning of a term is intended, it will be explicitly set forth or otherwise apparent from the disclosure.

Reference will now be made to several embodiments of the present invention, examples of which are illustrated in the accompanying figures for purposes of illustration only. One skilled in the art will readily recognize from the following description that alternative embodiments of the structures and methods illustrated herein may be employed without departing from the principles of claimed invention.

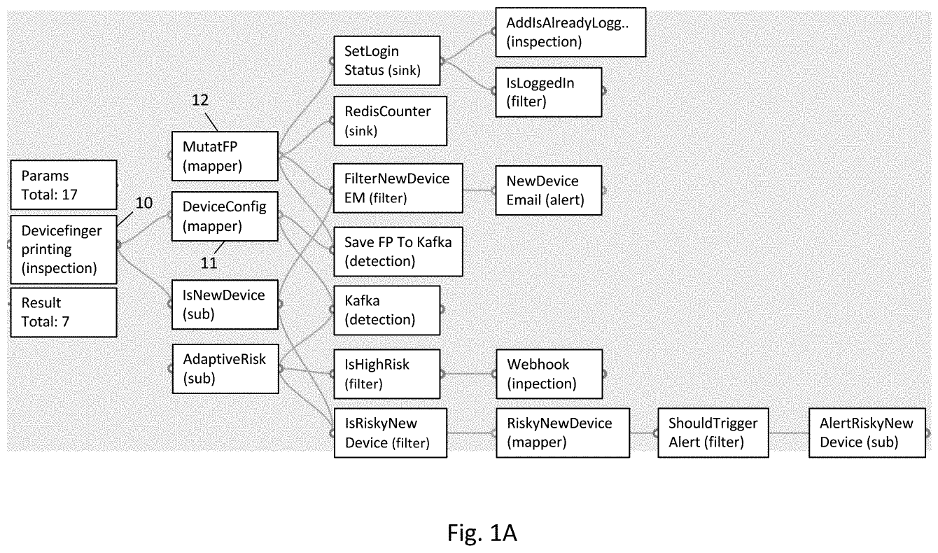

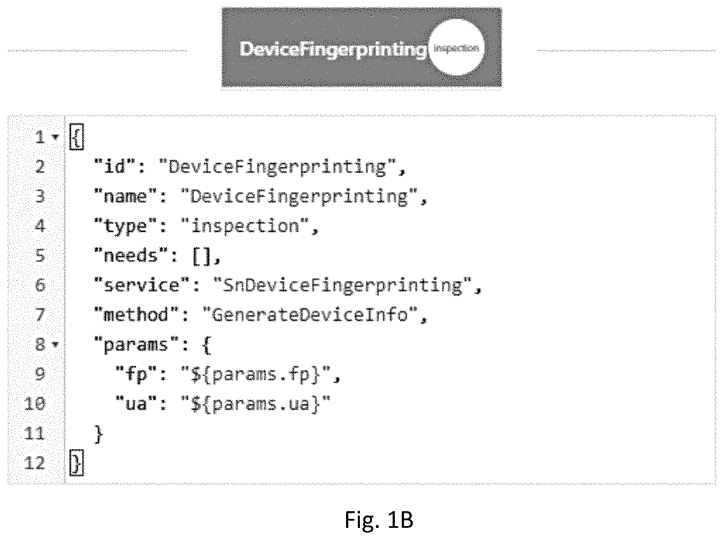

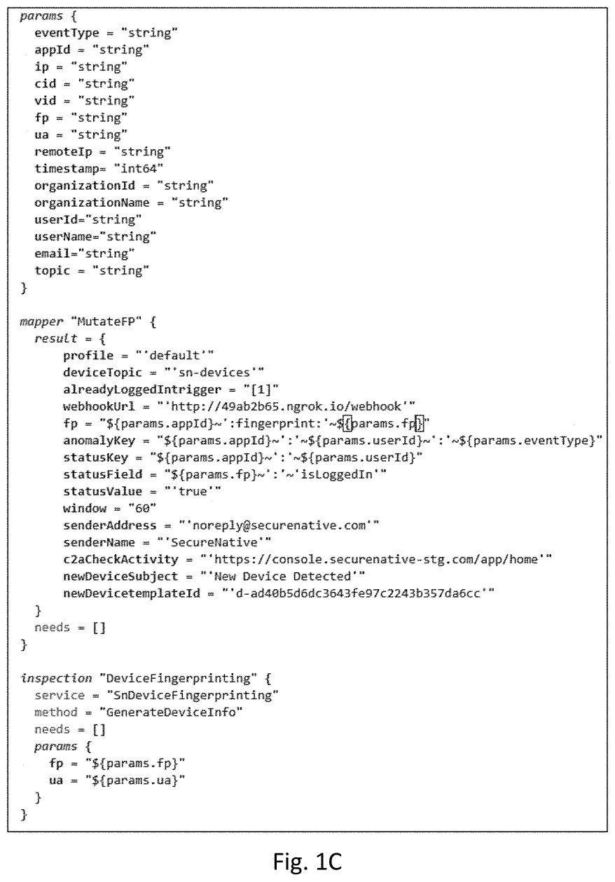

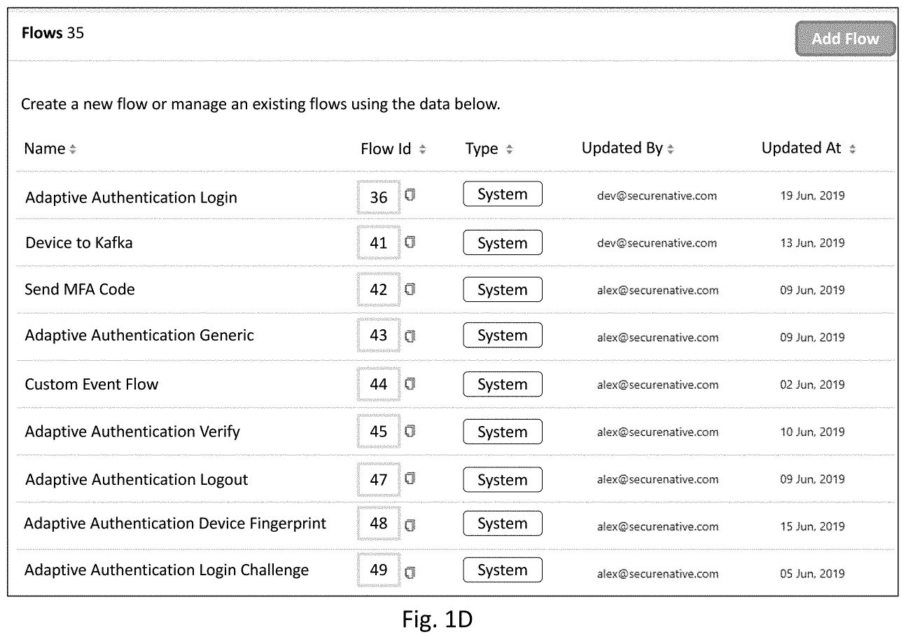

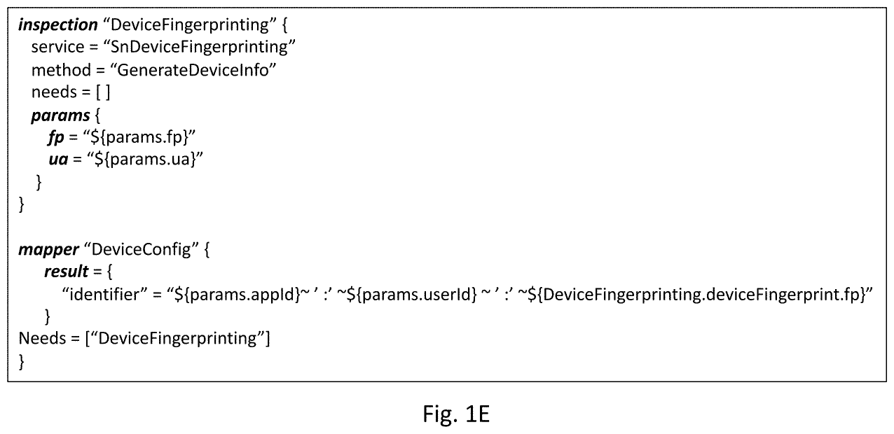

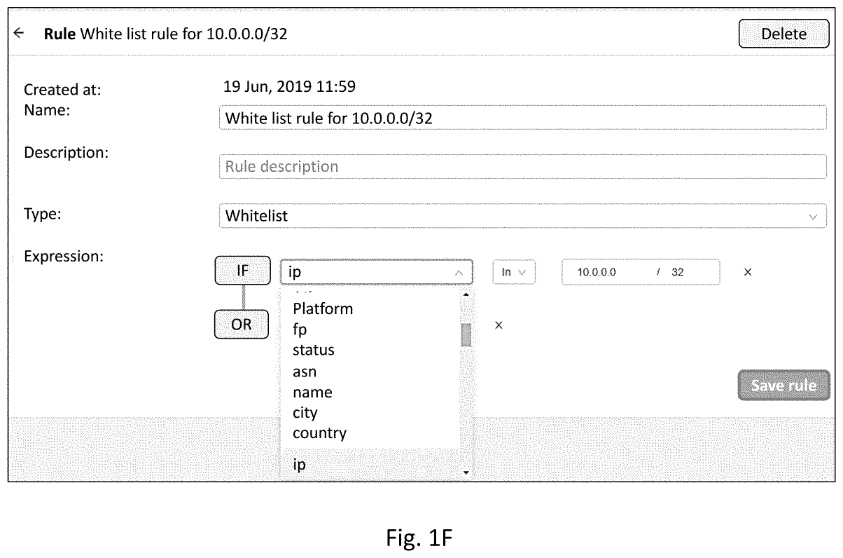

Throughout this description the term “flow” is used to indicate an abstraction layer of security services complete with policies, workflows and automation that can be deployed sequentially or in parallel and combines the output of the various services in a unified response. For example, flows may refer to authentication services such as adaptive authentication login, adaptive authentication logout, send Multi-Factor Authentication (MFA) code, adaptive authentication device fingerprint, adaptive authentication user signup, etc. FIG. 1A shows a screen layout example of an adaptive authentication login flow in a graph form, according to an embodiment of the invention. In this example, adaptive authentication login involves a device fingerprinting inspection service 10. FIG. 1B shows a code example of the device fingerprinting inspection service, according to an embodiment of the invention. FIG. 1C shows a screen layout of a code editor example of the adaptive authentication login flow, according to an embodiment of the invention. In this example the code of the flow comprises (i) a parameters section (indicated as “params” in the figures) that refers mostly to strings parameters such as user ID, user name, organization ID, email, IP address, etc., (ii) a mapper section (e.g., as indicated by numerals 11 and 12 in FIG. 1A) that takes customized response data from a service (e.g., device fingerprinting, as indicated by numeral 10 in FIG. 1A) and mutates to customized response (i.e., maps data obtained from one service to data that can be “understandable” by another or different service (in particular it maps data between non-related services), and (iii) the device fingerprinting inspection.

According to an embodiment of the invention, the present invention relates to a self-serve Security-Infrastructure-as-a-Service (SEC IAAS) platform that provides online cyber security services that provide high-level APIs used to dereference various low-level details of underlying network infrastructure like physical computing resources, location, data partitioning, scaling, security, backup etc.

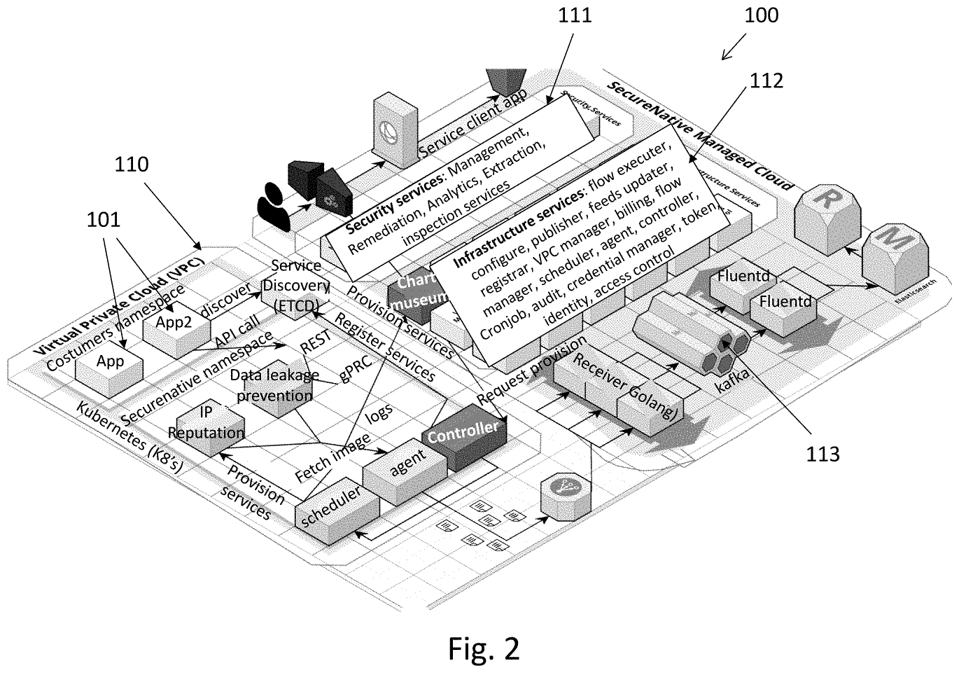

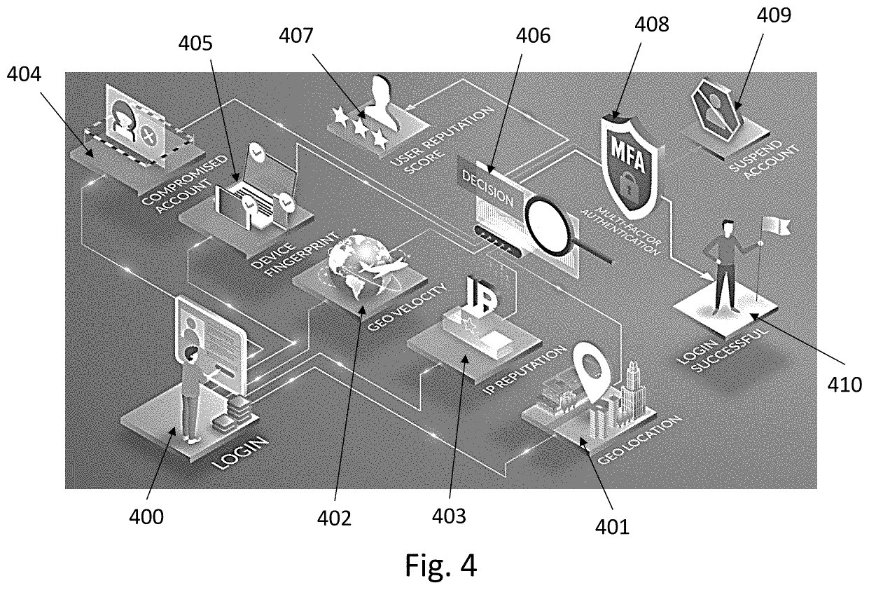

According to an embodiment of the invention, the SEC IAAS platform involves the following components:
Flow Manager and Sub-Flows (e.g., see a screen layout example in FIG. 1D, which shows a user interface of a flow manager that enables to manage flows such as adaptive authentication login as described hereinabove with respect to FIGS. 1A-1C, device to APACHE kafka* (e.g., as indicated by numeral 113 in FIG. 2), send MFA code, etc.). The flow manager may involve the following capabilities:
   Domain Specific Language (DSL) services linking as code. This enables to build customized modeling tools and essentially define a new modeling language and implement it very simply. For example, a specialized language may be used to describe a user interface, a business process, a database, or the flow of information, and then used to generate code from those descriptions;
   Parallel and sequential execution of flows;
   Sub-flows executions; A sub-flow is a flow that is executed within a flow. For example, remediation sub-flow based on user risk scoring for revoking user in organization active directory;
   Real-time and scheduled flows;
   Execution triggers (Based on events as will be described in further details hereinafter);
   Contextual execution;
   Condition based execution;
Data and Response Mutation
   Taking customized response data from a service (e.g., device fingerprinting) and mutates to customized response, i.e., mapping data obtained from one service to data that can be “understandable” by another or different service. In other words, provides in/out data transformation between services. FIG. 1E shows a screen layout example of a code for data and response mutation with respect to a device fingerprinting service, which comprises a device inspection section, and a mapper section that mutates response data of the inspected device to customized response;
Rule Engine
   Ability to define rules based on services parameters and not services. So, the rules are detached from the services (definition) yet can influence the service execution and results. FIG. 1F shows an example of a “whitelist” rule for IP address 10.0.0.0/32. The IP parameter is introduced by a service and can be used by other services, so in the rule case, every place the IP is used the rule will be invoked to, for example, approve source IP from specific IP range;
API Keys and Management
   Service, Flows and Sub-Flows level API keys. The API keys may act as both a unique identifier and a secret token for authentication, and may comprise a set of access rights on the API associated with it. For example, in a case of an adaptive authentication login flow, the flow manager enables to use API Keys for calling one or more APIs, such as “GEO velocity API” that compares current and login history to determine whether an improbable travel event has occurred, “IP reputation API” that provides reputation information for a source IP address, etc.;
Customized Integrations: Javascript Agent, SDK and Modules
   A JavaScript agent is configured to track activity on a website. The JavaScript agent runs in the browser, and can be used to calculate fingerprint, captcha execute MFA or any other action that is defined by a service or flow in the platform. For example, the JavaScript agent does not calculate a fingerprint in the browser. Instead it uses a lightweight and fast JavaScript agent that collects several device signals and securely sends them to remote servers of the system of the present invention. This may help prevent reverse engineering and spoofing of a fingerprint by more advanced bots. For example, information received from the JavaScript agent can be used to detect unusual behavior, identify malicious users, bots and other bad actors, e.g. by using dedicated decision engine or incorporate the provided data into a client system. In addition, a cookie can be added to a user's browser, so that the system can identify them between requests. For example, the JavaScript agent can be added as the first element inside the tag on every webpage one wants to monitor for suspicious visitors;
   SDK's can be used to quickly integrate to the system's API's. For example, the following programming languages can be supported: NodeJS and can be installed via NPM (JavaScript) or via maven (Java);
APIs and WebHooks
   Synchronous response via APIs, Services and flows can be called via APIs and provide immediate response to the request. For example, user risk scoring.
   Asynchronies response via webhooks—A WebHook is an HTTP callback: an HTTP POST that occurs when certain event happens, a WebHook is used to provide event-notification via HTTP POST. The system of the present invention implements WebHooks in a way that a client of the system may use them to perform a POST message to a URL when certain event happens. Using WebHooks the client can extend, customize, and integrate the system's flows with application of the client. Using WebHooks a client application can receive valuable information when events happens, rather than continually polling for that data and receiving nothing valuable most of the time. When one of those events is triggered, the system sends a HTTP POST payload to the WebHook's configured URL. For example, WebHooks can be used to perform an action like: blocking a user, notifying a user for the client's production server, etc.;
Events—the system of the present invention uses events as triggers for flows, when an event is received, it will automatically trigger a flow that is associated with it. For example, the system may provide built-in events that have already predefined flows that are associated with them, but system's clients can define Custom Events and customize flows that are executed for them (i.e., Pre-defined and custom triggers for flows, as well as Custom binding between event and flows) For example, a built-in can be an event that indicates that user successfully logged in (LOG_IN), an event that indicates that a user was requested to solve authentication challenge to verify his identity (LOG_IN_CHALLENGE), an event indicating that a user failed to authenticate (LOG_IN_FAILURE), an event that indicates that a user successfully logged out (LOG_OUT), etc. As indicated with respect to FIG. 4, a simple secure login event (400) may comprise components such as account compromised (404) and IP classification (403), and the code may look like the followings:

curl -X GET
https://securenative.com/executor/opt/v1/execute/29021984?account=exam
ple@company.com&isPartial=true&password_hash=7ce05&clientIP=103.21.1
84.0 \
-H ‘Accept: application/json’ \ -H ‘Authorization: API_KEY’

Wherein the parameters of the above example login code are described in Table 1:

TABLE 1

| Parameter | In | Type | Required | Example Value | Description |
|---|---|---|---|---|---|
| flowId | path | integer | Yes | 29021984 | The id of the flow |
| account | path | string | Yes | example@company.com | The email account |
| | | | | | to check |
| isPartial | path | Boolean | No | true | Specify if password |
| | | | | | hash could contain |
| | | | | | first 5 characters |
| | | | | | for anonymity (k- |
| | | | | | Anonymity model). |
| | | | | | false by default |
| password_hash | path | string | Yes | 7ce05 | SMA-1 hash of a |
| | | | | | UTF-8 encoded |
| | | | | | password |
| clientIP | path | string | Yes | 103.21.184.0 | The ip address |
| | | | | | to classify |

According to an embodiment of the present invention, services in the platform of the present invention may include Code to Service—Representational State Transfer (REST) API and gRPC (i.e., an RPC framework that can run in any environment and that can be used to efficiently connect services in and across data centers with pluggable support for load balancing, tracing, health checking and authentication), High availability, Scalability, Redundancy, Service Discovery, Low latency communication, integration with infrastructure services, Auto documentation, Billing (On demand charging), API Keys (Permissions), Auto SDK, Auto integration into Agent, etc.

The following discussion is intended to provide a brief, general description of a suitable computing environment in which the cyber security platform may be implemented. While the invention will be described in the general context of program modules or codes that execute in conjunction with an application program that runs on an operating system on a computer system, those skilled in the art will recognize that the invention may also be implemented in combination with other program modules. The functions described herein may be performed by executable code and instructions stored in computer readable medium and running on one or more processor-based systems. Embodiments of the invention may be implemented as a computer process, e.g., a computer system that encodes a computer program of instructions for executing the computer process.

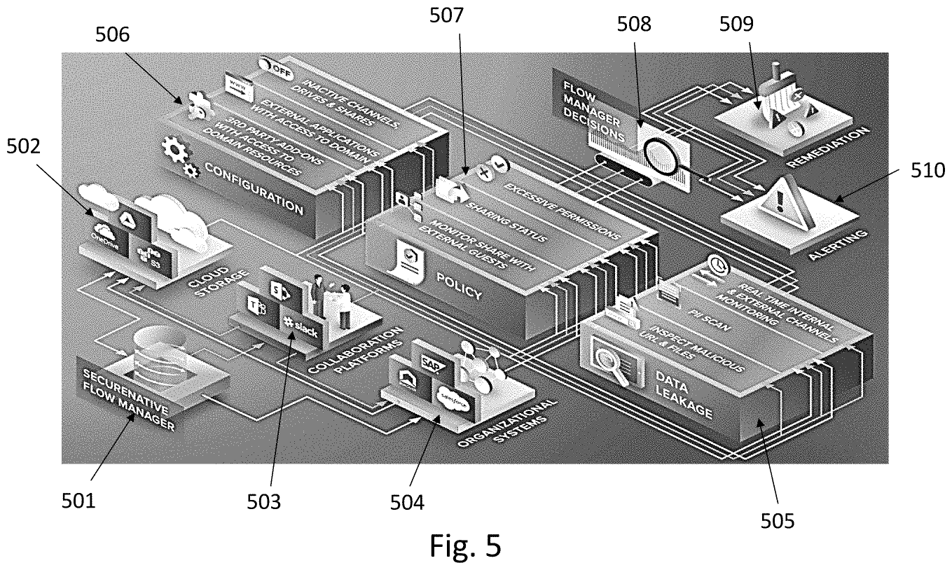

FIG. 2 schematically illustrates the architecture of a cyber security platform 100, according to an embodiment of the invention. Platform 100 comprises a virtual private cloud (VPC) 110 that includes one or more applications 101 that are configured to communicate via interfaces such as API, Command Line Interface (CLI), serverless scripts, etc., services such as security services 111, operation services and infrastructure services 112, wherein each service has a manager and cluster, one or more Virtual Machine (VM) nodes, an Infrastructure-as-a-Service (IaaS) agnostic (i.e., on-demand cloud computing platforms such as AWS, Google cloud, etc. as indicated by numeral 502 in FIG. 5), and one or more databases such as Apache CouchDB and Remote Dictionary Server (Redis) which is an in-memory key-value database.

According to an embodiment of the invention, the Security Infrastructure-as-a-Service (SEC IaaS) includes the following pillars:
Connectors: Source (IN) and Sink (OUT) services;
Mapper: Mutation services;
Rules: Splitter (Yes or No channels), Router (Switch/Case based on expression), Filter (Condition);
Data: Save state in Cache or Persistent storage;
Detection: Inspection services (DLP, IP BOT_);
Analyze: Intelligence—Anomaly Detection;
Alert: SMS, Email, etc. services;
Actions: Remediation services; and
Dashboard: Dashboard services.

According to an embodiment of the invention, the API of the security services comprises the vector pillar, the payload pillar and the extract pillar, the API of the operation services comprise the inspect and intelligence pillars, and the API of the infrastructure services comprises the remediation and management pillars, as schematically illustrated in FIG. 2.

According to an embodiment of the invention, flows can be used to combine various services from multiple pillars together and to create a use-case in accordance with specific needs of an enterprise. Flows can be triggered by the security platform 100 upon schedule or in real-time upon user request and can run a sequence of serial or parallel actions in response. Flows can be executed on demand as auto-scaled automatically upon demand, thus resulting in variety of possibilities whether one wants to build a security use-case, monitor cloud app configurations and permissions, find personally identifying in formation (pii) in data or detect anomaly in usage. For example, flows can be created using simple declarative configuration language, such as domain-specific language (DSL) which may help developers to track the complete history and versioning flows.

According to an embodiment of the invention, the platform allows to add custom rules to extend service default policies. For example, rules can be defined on every service output field and support multiple field types such as: DateTime, Text, IP, URL and Range. In addition, the platform may allow to group multiple rules together and conditionally execute specific group.

### API for Flow Manager

According to an embodiment of the invention, the flow consists of multiple orchestrated services and predefined rules that linked together and provides solution to business security use-case. The security platform may provide two types of flows:
Predefined Flow that is created and maintained by the platform 100. Because Flow Manager has a dynamic response based on user-defined rules, platform 100 cannot show a direct response; and
Customized Flow that is created and maintained by a user.

According to an embodiment of the invention, platform 100 uses events as triggers for Flows, when an event is received from a user, it will automatically trigger a flow that is associated with it. Built in events have already predefined flows that are associated with them, but a user may define Custom Events and customize flows that are executed for them.

According to an embodiment of the invention, in order to integrate with an application, platform 100 may use the concept of an agent which is a lightweight software component (e.g., a regular dependency package) that is installed into the application and allows sending events, capturing and inspecting application's requests. For example, an agent can be installed using any suitable package manager depending on the language that is used for a given web server. Due to its lightweight, the agent doesn't impact the application's performance; the events are submitted asynchronously and resilient to network failures. After platform 100 receives an event from the application it will automatically trigger security flows that are associated with the event.

For example, the agent can be a JavaScript Agent that is configured to track activity on a website. In this example, the JavaScript agent runs in a browser and it can be used to calculate fingerprint, captcha, etc. In one implementation, the JavaScript agent does not calculate a fingerprint in the browser, and instead it uses a lightweight and fast JavaScript agent that collects several device signals and securely sends them to platform 100. This may prevent reverse engineering and spoofing of a fingerprint by malicious bots. This information used to detect unusual behavior, identify malicious users, bots and other bad actors. Accordingly, platform 100 may provide the data to a decision engine. A cookie can be added to the browser, so that platform 100 can identify them between requests. Alternatively, the agent can be a Server-side Agent+SDK.

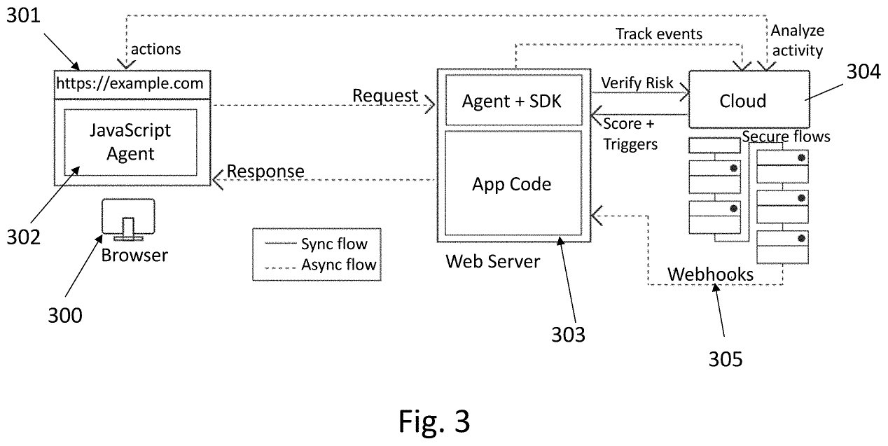

FIG. 3 schematically illustrates a request flow, according to an embodiment of the invention. The request flow may work as follows: when a website 301 loads, the JavaScript Agent 302 collects indicators from a browser 300. The system's web server 303 and cloud 304 uses those collected indicators to uniquely identify every visitor and create a device fingerprint.

In addition to using the system's SDK, the JavaScript agent 302 reports events which are operations that are requested by the user to perform/already completed such us: login, logout, signup, profile update, etc. The system may use events to learn more about the user and accordingly to build a behavior profile. Events acts as triggers that the system uses to run security flows, if the system detects an anomaly behavior, the system automatically will trigger a webhook 305 into the application, this allows to take action in order to protect the user.

Optionally, the system may also expose a verify endpoint which can be called before every sensitive operation, the system analyzes the collected data and anomaly behavior and accordingly may return to a risk score with security triggers.

The system's agents send requests to a remote server via secure HTTPS connection, thus as more data received the better the system can leverage it and provide better results. The received events are automatically cached locally and the system's SDK/Agent will insure that they are delivered securely in batches to the remote server.

All the above will be better understood through the following illustrative and non-limitative examples.

FIG. 4 schematically illustrates an implementation of an adaptive authentication using platform 100, according to an embodiment of the invention.

Example 1: Adaptive authentication refers to risk based authentication, which is an example for method of using custom policies to identify and stop risky logins in their tracks. A decision engine 406 can be used to suspend an account (as indicated by numeral 409), or to enable a successful login (as indicated by numeral 410), e.g., by further using MFA 408 and user reputation score 407.

### User Authentication to Prevent Account Takeover

With the system's adaptive authentication, the authentication process uses a user's typical behavior patterns as a second factor of authentication. Rather than expect users to improve their security behavior, the system use their behaviors to identify them and improve the security. In this example, each user is login checked against behavioral anomalies indicating that there is a violation in process. The multi-layered approach traverses the characteristics of each login through various filters and analyzers so that the system can determine if a user is really who he claims he is.

The authentication of a login user 400 may use one or more of the followings elements as also schematically demonstrated in FIG. 4:
Unrecognized and new devices (as indicated by numeral 405),
Whitelist and blacklist countries;
Geo-location access anomaly detection (as indicated by numeral 401);
GeoVelocity checking (as indicated by numeral 402);
High risk IP addresses;
Bad Reputation IP addresses (as indicated by numeral 403),
Blacklisted IP addresses;
Tor and other anonymity networks,
Access from shared hosting and cloud providers;
Access from public proxies and VPN Services; and
New and unusual login locations.

### Power Up Authentication by Using Custom Workflows

The system's Risk Score allows to request a risk score in real-time for every user login. The score—is instantly calculated and can be used to approve the login, trigger 2FA or block the bad login attempt if the risk is too high.

### Example 2: Zero Trust Authentication

### Contextual Authentication

Many companies now enforce two-factor authentication (2FA) in the sign-in process to ensure that only authenticated users gain access to sensitive data, by enabling 2FA the system forces users to wait to receive a verify code and verifying it before gaining access to sensitive resource.

The system of the present invention improves the log-in process by creating a behavioral profile for each user accessing the app and analyzing whether each user is actually who he says he is. Even if 2FA has been disabled by a user, hacker or bot—all logins are still monitored for high-risk behavioral anomalies. If the system detects a login feature that does not match a user's behavioral profile—a suspicious IP address, a new country, an unrecognized device or any of many other risk factors—notifications can be send to the app and the users and make them aware of the threat.

The system of the present invention allows for an improved user experience in the app by not asking for a two-factor code each time a user log in. Instead, the system verifies the identity of the user based on the risk profile of the current login date. If the user does not have two factors enabled and the login risk assessment value is high, the user can be notified, e.g., by e-mail or SMS that his or her account is compromised.

### Continuous Authentication

In the prior-art, all the traditional authentication systems performs authentication only during the login phase and most active sessions don't have a mechanism to detect if the current user is the same as the one that was originally authenticated. In contradiction, the system of the present invention provides a real-time score flows, which can be used to identify a user based on a behavioral profile which is refined during the usage of your application. The system enables the application to check if a user is no longer the person who is claims to be, during the lifetime of the app. If the risk to a user is medium, a two-factor authentication code can be used to confirm the user identity. If the risk is extremely high, actions can be taking such as ending the user's session and forcing log out. By verifying the user before making critical actions in the application, than mitigating the risks of session hijacking or Man in the Middle (MITM) attacks that may have happened since the user last authenticated.

### Example 3: Fraud Detection

The system can stop bad actors at the point of login by using a number of analyzers and request filters to identify user behavior that does not match a known user pattern. The system may gain access to community of customers and partners to leverage a growing database of known bad actors, devices, locations, IPs, request rates, open threat exchange program and attack patterns.

The system provides real-time risk algorithms which allow making risk-based decisions. The app can ask the system's API to verify the identity of a user based on the behaviors the system already knows about them just before processing a sensitive operation. If high risks score obtained, the user may be challenged with an additional security challenges. If the risk is extremely high then it might block the operation completely. By taking these actions before sensitive operations a potentially fraudulent operation transaction and the unwanted consequences that might come with it can be avoided.

### Example 4: Data Leakage

FIG. 5 schematically illustrates an implementation of a security service in form of data leakage and protection using the cyber security platform, according to an embodiment of the invention. The security platform comprises a flow manager 501, cloud storage 502, one or more collaboration platforms 503 (e.g., such as Slack), organization systems 504 (e.g., such as SAP), a data leakage service 505 (e.g., that may involve inspection of malicious URL and files, PII scan, real-time internal & external channel monitoring, etc.), configurations 506 (e.g., 3^{rd} party add-ons with access to domain resources, external application with access to domain, inactive channels, drivers & shares, etc.), policies 507 (e.g., monitor shares with external guests, sharing status, excessive permissions, etc.), a flow manager decision engine 506 that is configured to decide whether to perform remediation tasks 509 or alerting 510 according to the policies 507.

As will be appreciated by the skilled person the system described hereinabove results in a self-serve platform, that in a matter of minutes one can tailor and write enterprise-grade security services, use-cases and solutions. The system provides the ability to address gaps across multiple cyber security segments, on-demand consumption model vs. vendor based enterprise license, enables Security teams/IT teams/business units can use UI to define use cases, decide which services are included, create rules and determine the flow of the services. Developers to self-sign up and use APIs to call specific services and pre-built solutions. Using the system of the present one may prebuilt solutions and platform services only for what is needed.

Unless otherwise indicated, the functions described hereinabove may be performed by executable code and instructions stored in computer readable medium and running on one or more processor-based systems. However, state machines, and/or hardwired electronic circuits can also be utilized. Further, with respect to the example processes described herein, not all the process states need to be reached, nor do the states have to be performed in the illustrated order. Further, certain process states that are illustrated as being serially performed can be performed in parallel.

The terms, “for example”, “e.g.”, “optionally”, as used herein, are intended to be used to introduce non-limiting examples. While certain references are made to certain example system components or services, other components and services can be used as well and/or the example components can be combined into fewer components and/or divided into further components.

All the above description and examples have been given for the purpose of illustration and are not intended to limit the invention in any way. Many different mechanisms and methods, electronic and logical elements can be employed, all without exceeding the scope of the invention.

1. A method of providing security infrastructure as a service, comprising:
a. Setting plurality of pillars, each of which adapted to handle different aspect of security services of a cyber security platform;
b. Providing a flow manager that is configured to handle a plurality of flows, wherein each flow is an abstraction layer of various security services together with policies, workflows and automation that are deployed sequentially or in parallel;
c. Combining the output of the various security services in a unified response; and
d. Consisting of services and components that can be written and transformed from code to enterprise-grade services based on the platform wrappers.

2. The method according to claim 1, wherein the flows are used to combine various services from multiple pillars together and create a use-case n accordance with specific needs of an enterprise.

3. The method according to claim 1, wherein the flows are triggered by the security platform upon schedule or in real-time upon user request in order to run a sequence of serial or parallel actions in response.

4. The method according to claim 1, wherein flows can be executed as auto-scaled automatically upon demand, thus resulting in variety of possibilities.

5. The method according to claim 1, wherein the flow manager uses Domain Specific Language (DSL) services linking as code to create the flows.

6. The method according to claim 1, wherein the flows are executed by execution triggers, contextual execution, or condition based execution.

7. The method according to claim 1, wherein the flows comprising taking customized response data from a service and mutating it to customized response.

8. The method according to claim 1, further comprising defining rules based on services parameters, thus the rules are detached from the services and yet can influence the service execution and results.

9. The method according to claim 1, wherein the flow manager enables to use API Keys for calling one or more APIs.

10. The method according to claim 1, further comprising integrating a JavaScript agent in a browser for tracking activity on a website.

11. The method according to claim 10, wherein the JavaScript agent runs in the browser, collects several device signals and securely sends them to remote servers for calculating fingerprint, captcha and MFA.

12. The method according to claim 10, further comprising receiving synchronous response via APIs, and asynchronies response from services via webhooks.

13. A system, comprising:
a) at least one processor; and
b) a memory comprising computer-readable instructions which when executed by the at least one processor causes the processor to execute a security infrastructure as a service, wherein the security infrastructure as a service:
i) Sets plurality of pillars, each of which adapted to handle different aspect of security services of a cyber security platform;
ii) Provides a flow manager that is configured to handle a plurality of flows, wherein each flow is an abstraction layer of various security services together with policies, workflows and automation that are deployed sequentially or in parallel; and
iii) combines the output of the various security services in a unified response.

14. A system according to claim 13, further comprising a rule engine for defining rules based on services parameters, by detaching rules from the services.
